(19) United States
(12) Patent Application Publication
(10) Pub. No.: US 2009/0201368 A1
(43) Pub. Date: Aug. 13, 2009

(54) GLAZING INSPECTION

(75) Inventor: Robert William Evans, Lancashire (GB)

Correspondence Address: BUCHANAN, INGERSOLL & ROONEY PC, POST OFFICE BOX 1404, ALEXANDRIA, VA, 22313-1404, US

(73) Assignee: Pilkington Group Limited, Merseyside (GB)

(21) Appl. No.: 12/304,412

(22) PCT Filed: Jun. 13, 2007
(86) PCT No.: PCT/GB2007/050334

§ 371 Date: Dec. 11, 2008

(30) Foreign Application Priority Data
Jun. 14, 2006 (GB) 0611747.7

(51) Int. Cl. H04N 7/18

(52) U.S. Cl. 348/127; 348/E07.085

(57) ABSTRACT

A glazing inspection apparatus for detecting edge faults in a ply of glass, and a method of inspection, is disclosed. The apparatus comprises a light source for illuminating a ply of glass, image capture means for capturing images of the edge and the upper and lower surfaces, adjacent the edge, of the ply of glass and focusing means for focusing the images of the edge and the upper and lower surfaces, adjacent the edge, of the ply of glass into the same focal plane. Preferably the focusing means comprises two triangular glass prisms located at one end of a parallelepiped glass block, on opposite sides of the block. Alternatively, the focusing means may comprise the parallelepiped glass block and a pair of mirrors.

The present invention relates to glazing inspection apparatus for, and a method of inspecting a glazing, in particular, inspecting a single ply of glass for edge defects.

During production, the glass used in automotive glazings is inspected for various defects that may affect the optical quality of the finished glazing product. For example, the glass may contain inclusions or faults, such as nickel sulphide inclusions or gas bubbles. Alternatively, faults may arise through distortion, thickness and curvature variations from the firing and bending processes used to shape the glass. For example, a secondary image may be seen when viewing an object through shaped glass.

One particular type of fault acquired through processing is edge faults. These arise from the cutting of glass to size and edgeworking (grinding and shaping) to produce a rounded or bevelled edge of a glass ply before shaping and firing. The presence of edge faults can be a major problem for further glass processing, such as encapsulation, as not only do chips or scratches affect the quality of the finished glazing, but some edge faults may cause health and safety issues, for example, by leading to a corner of the glass being sharp enough to cut a hand or finger. From a quality control point of view, it is therefore desirable to inspect glass for edge faults before final processing. Edge faults are also unacceptable to final users, such as car manufacturers.

There are three main types of edge faults that may be observed. Firstly, the edge of the glass may be chipped. These chips may arise from cracking or fracture during the cutting process, and may extend far enough into the bulk of the glass ply not to be ground out using normal grinding techniques. Secondly, the edge of the glass may be covered in numerous small chips, known as brillantatura. These chips give a frosty appearance to the edge of the glass, which seems to glisten. Thirdly, where the edge of the glass is not ground correctly, regions giving a mirror (as opposed to a diffuse) reflection are formed. These regions are known as shiners, and if they occur at the corners of the glass, may result in sharp edges.

One way in which edge faults can be detected is by using an optical inspection system. WO01/86268 discloses an optical inspection system, comprising at least one laser aligned in the plane of the edge of a ply of glass as it passes by on a conveyor belt. The reflected light from the laser is detected by a camera mounted off the plane of the edge of the ply of glass, and the variation in reflectivity (compensated for any vibration of the glass as it travels along the belt) is used to detect edge faults. Four lasers maybe used simultaneously to detect faults in all edges of a ply of glass. In addition, a transmission optical inspection system having a light source mounted above the conveyor and a camera below can be used to detect any faults in the bulk of the ply of glass at the same time.

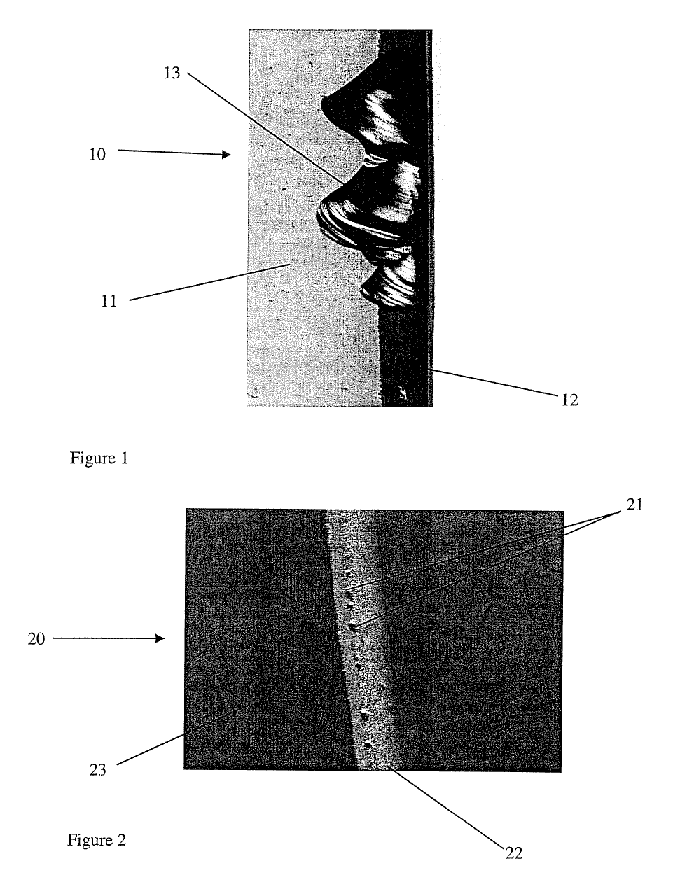

The laser system in WO01/86268 is designed to consider faults along the edge only. Whilst this will detect the majority of edge faults such as brilliantatura and shiners, one difficulty which may occur is in the detection of edge chips. FIG. 1 shows a ply of glass 10 having an edge 11 and an upper surface 12. The major portion of the chip 13 is in the upper surface 12 of the ply of glass 10, and not along the edge 11. A large portion of the chip (in practice, up to 80%) may be seen on the surface of the ply of glass, in addition to the edge. Some chips may be entirely on the surface of the glass, abutting the edge. This means that some edge chips, where the majority of the chip is on one of the surfaces of the ply of glass, and not on the actual edge, may be misinterpreted, or missed completely.

There is therefore a need to be able to successfully and reliably detect all edge faults which lead to quality control issues in glazing manufacture.

The present invention aims to address these problems by providing a glazing inspection apparatus for detecting edge faults in a ply of glass, comprising a light source for illuminating a ply of glass, image capture means for capturing images of the edge and the upper and lower surfaces, adjacent the edge of the ply of glass and focusing means for focusing the images of the edge and the upper and lower surfaces, adjacent the edge, of the ply of glass into the same focal plane.

By focusing images of the edge and upper and lower surfaces, adjacent the edge, of a ply of glass, it is possible to detect edge faults which occur partially, predominately or wholly on a surface of the ply, and which would not be detected fully using edge inspection only. This maximises the likelihood of detecting all edge faults, and results in reliable and successful quality control.

Preferably, the focusing means comprises a prism assembly comprising a parallelepiped glass block and two triangular glass prisms, such that the block focuses light from the edge of the ply of glass and the triangular prisms from the surfaces of the ply of glass. Preferably, the triangular prisms are located on opposite sides of the glass block at one end, and form a cavity into which the edge and upper and lower surfaces, adjacent the edge, of the ply of glass are placed.

Alternatively, the focusing means may comprise a parallelepiped glass block and two mirrors, wherein the block focuses light from the edge of the ply of glass and the mirrors from the surfaces of the ply of glass.

Preferably, a single image capture device is used to capture the images the edge and the upper and lower surfaces, adjacent the edge, of the ply of glass. Preferably, the image capture device is a camera. Preferably, camera is a line scan camera, more preferably a CCD (charge-coupled device) camera.

Preferably, the light source is a linear array of light emitting diodes (LEDs).

The apparatus may further comprise means to rotate the ply of glass such that all of the edge and the upper and lower surfaces, adjacent the edge of the ply of glass are exposed to the image capture device. Preferably, the apparatus also comprises means to detect variations in the images received by the image capture device, wherein the variations indicate the presence of edge faults.

At least two light sources may be used to illuminate the focusing means from at least two different positions. Preferably, four light sources are sued to illuminate the focusing means from four different positions.

The present invention also provides a method of inspecting the edge of a ply of glass for edge faults, comprising illuminating a ply of glass, capturing images of the edge and the upper and lower surfaces, adjacent the edge, of the ply of glass and focusing the images of the edge and the upper and lower surfaces, adjacent the edge, of the ply of glass into the same focal plane using focusing means.

By focusing images of the edge an upper and lower surfaces, adjacent the edge, of a ply of glass, it is possible to detect edge faults which occur partially or predominately on a surface of the ply, and which would not be detected fully using edge illumination only.

Preferably, the focusing means comprises a prism assembly comprising a parallelepiped glass block and two triangular glass prisms, such that the block focuses light from the edge of the ply of glass and the triangular prisms from the surfaces of the ply of glass. Preferably, the triangular prisms are located on opposite sides of the glass block at one end, and form a cavity into which the edge and upper and lower surfaces, adjacent the edge, of the ply of glass are placed.

Alternatively, the focusing means may comprise a parallelepiped glass block and two mirrors, wherein the block focuses light from the edge of the ply of glass and the mirrors from the surfaces of the ply of glass.

Preferably, a single image capture device is used to capture the images the edge and the upper and lower surfaces, adjacent the edge, of the ply of glass. Preferably, the image capture device is a camera. Preferably, camera is a line scan camera, more preferably a CCD (charge-coupled device) camera.

Preferably, the apparatus the light source is a linear array of light emitting diodes (LEDs).

Preferably, the method further comprises rotating the ply of glass such that all of the edge and the upper and lower surfaces, adjacent the edge of the ply of glass are exposed to the image capture device.

Preferably, the method further comprises detecting variations in the images received by the image capture device, and using the variations to determine whether there are any edge faults present.

At least two light sources may be used to illuminate the focusing means from at least two different positions. Preferably, four light sources are sued to illuminate the focusing means from four different positions.

The present invention will now be described by way of example only, and with reference to the accompanying drawings in which:

FIG. 1, referred to above, is a photograph illustrating the proportion of an edge chip on a surface of a ply of glass;

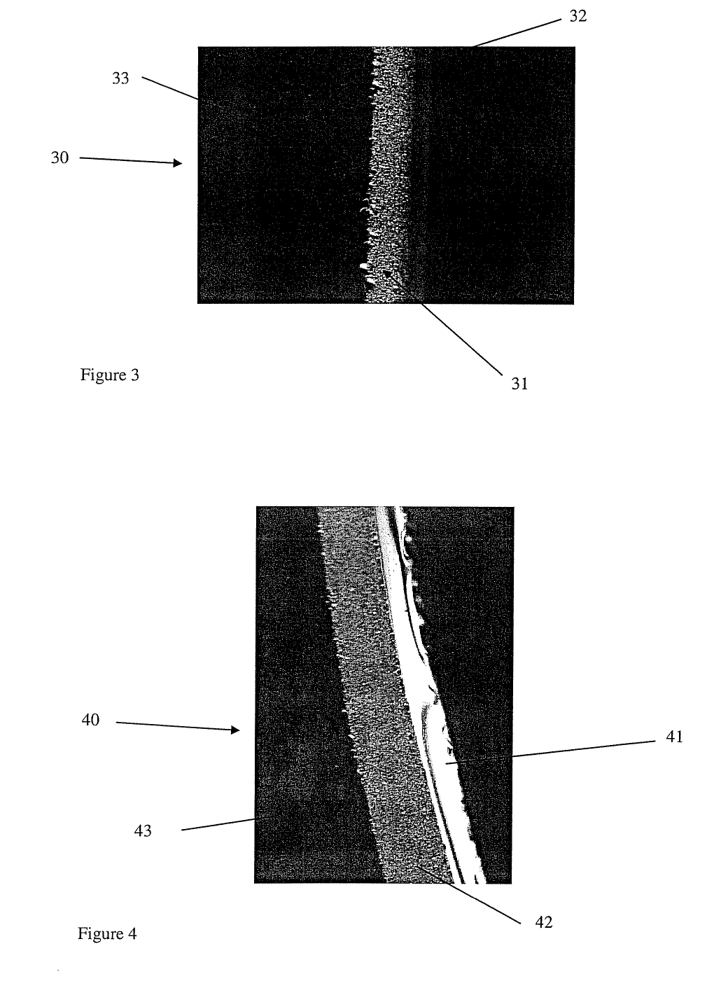

FIG. 2 is a photograph illustrating an edge chip in a ply of glass;

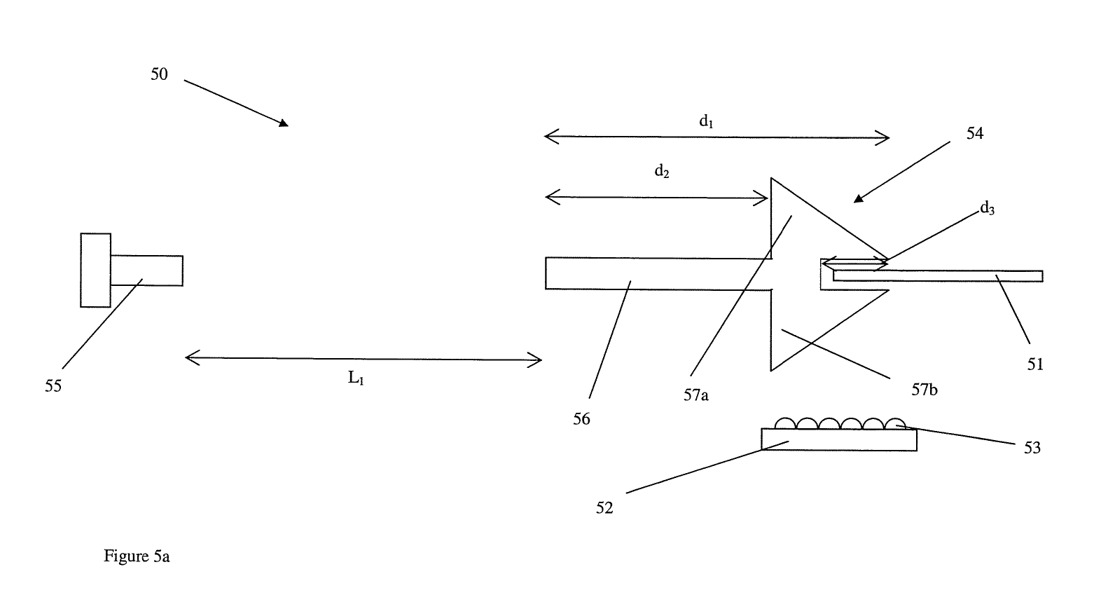

FIG. 3 is a photograph illustrating brilliantatura on the edge of a ply of glass;

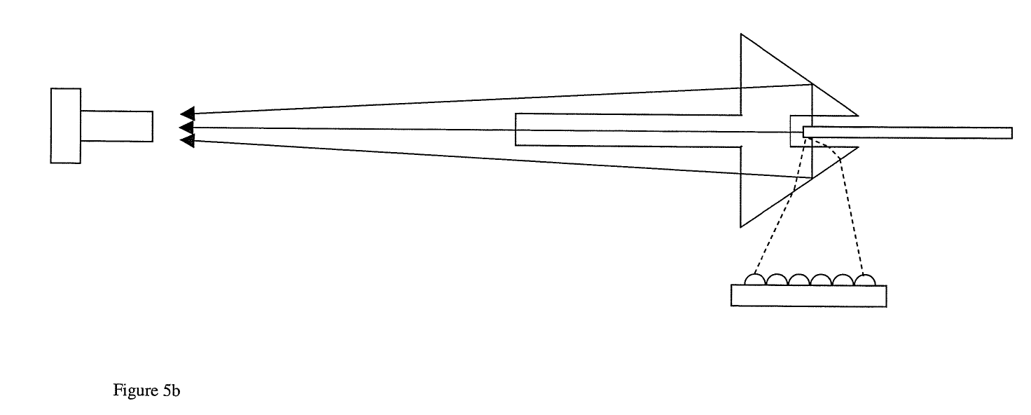

FIG. 4 is a photograph illustrating shiners on the edge of a ply of glass;

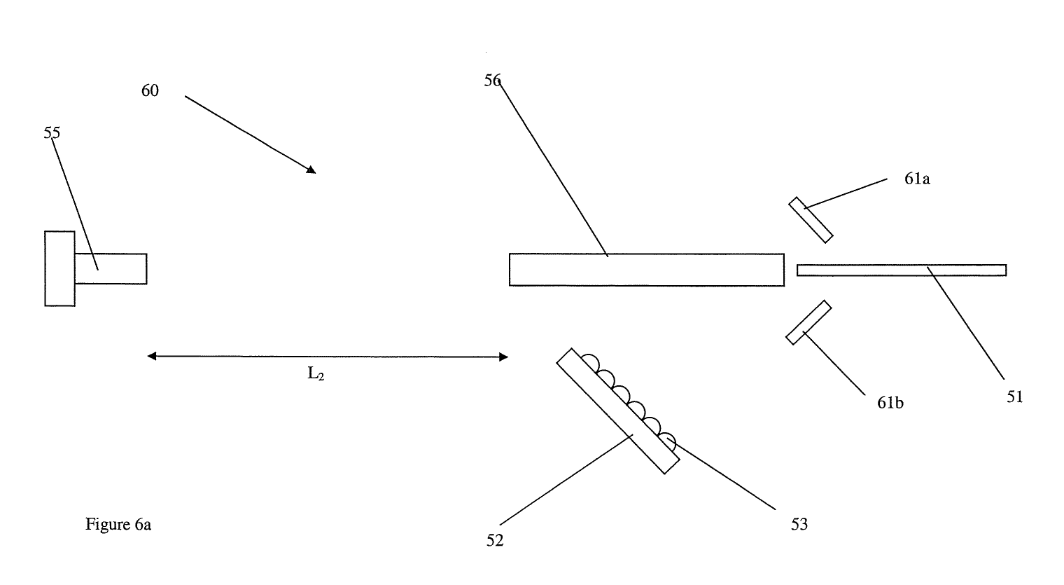

FIG. 5a is a schematic diagram an optical inspection system in accordance with the present invention;

FIG. 5b is a schematic diagram of the optical inspection system in FIG. 5a, showing only the ray paths;

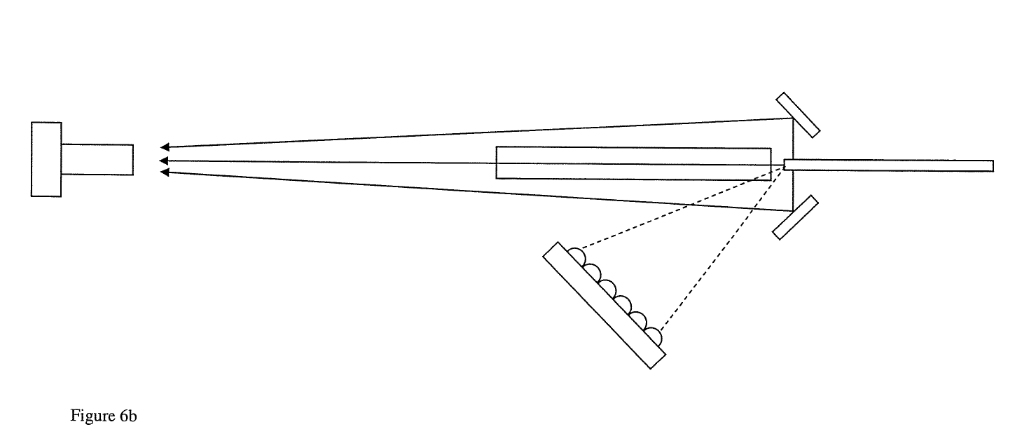

FIG. 6a is a schematic diagram of a modified version of the optical inspection system;

FIG. 6b is a schematic diagram of the modified optical inspection system in FIG. 6a, showing only the ray paths;

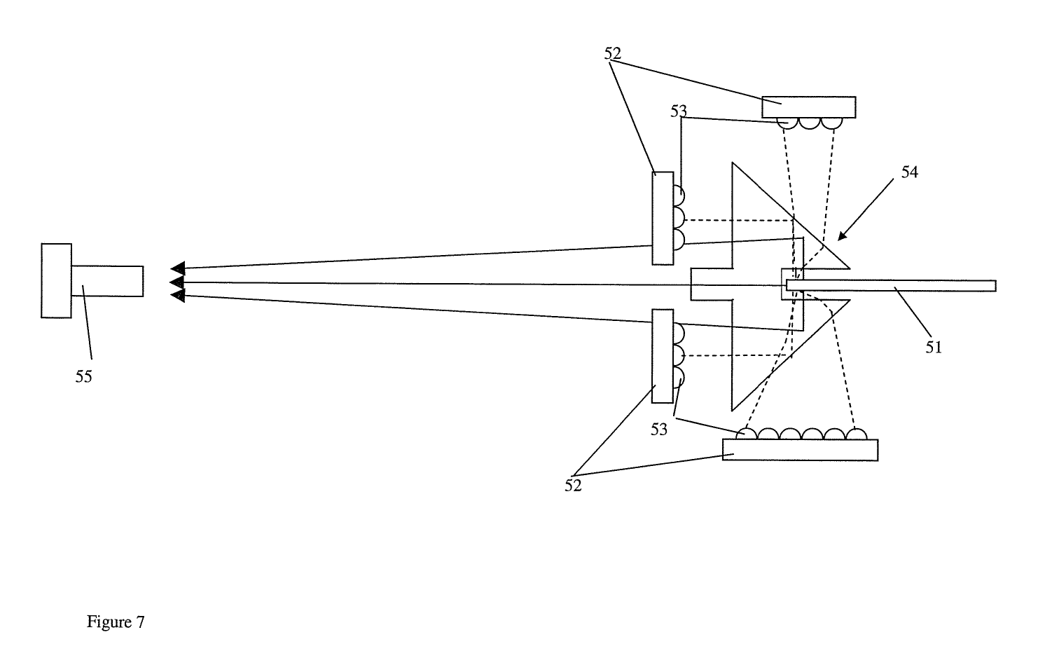

FIG. 7 is a schematic diagram illustrating an alternative illumination system; and

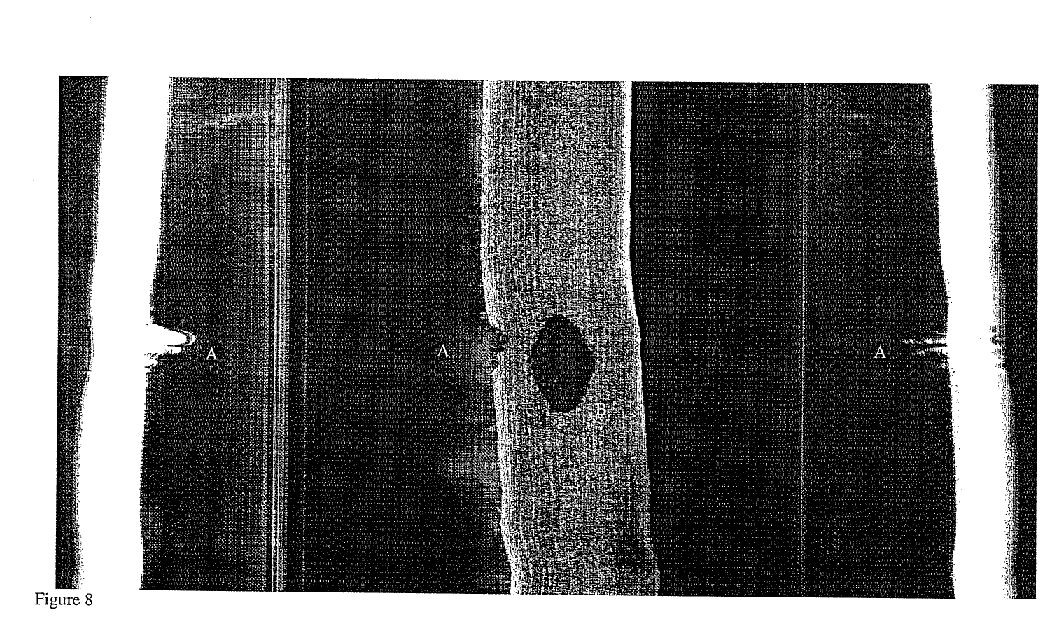

FIG. 8 is an image of a ply of glass taken using the system shown in FIG. 5a.

In the present invention, it has been appreciated that by providing means to focus images of the edge and adjacent surfaces of a ply of glass into the same focal plane, the captured images may be compared directly to identify faults and features in the glass. Preferably, the images from the edge and surfaces adjacent the edge of the ply of glass are focussed into the same focal plane and captured by a single image capture device. This is particularly advantageous as it allows the image capture and processing to be carried out within a short time frame, and is ideal for introduction onto a glass production or processing line. However, it may be desirable to use more than one image capture device, for example, one for each of the edge, the upper and lower surfaces adjacent the edge, and to integrate the images, each of which is in the same focal plane, during an image processing stage.

In order to illustrate the additional information available from simultaneously viewing the edge and adjacent upper surface of a ply of glass, photographs were taken FIGS. 2, 3 and 4 are photographs, taken in a dark field configuration (using light refracted by the glass) and showing edge faults in both the edge and adjacent surface.

FIG. 2 shows a ply of glass 20 having series of chips 21 along one edge 22. In addition to the edge 22, the upper 23 surface of the ply of glass 20 is shown. FIG. 3 illustrates brilliantatura, and shows a ply of glass 30 having a plurality of small chips 31 along one edge 32 of the ply of glass 30. Again, both the edge 32 and upper 33 surface of the ply of glass 30 are shown. FIG. 4 illustrates shiners, and shows a ply of glass 40 having regions of mirror reflection 41 along one edge 42. Again, both the edge 42 and upper surface 43 of the ply of glass 40 are shown. In each photograph, the extent to which each type of edge fault also manifests on the surface of the ply of glass is clear, showing the volume of data missed by conventional optical inspection systems that only view the edge of a ply of glass.

However, even greater amounts of information can be obtained by viewing the edge, upper surface and lower surface of a ply of glass. It is this approach taken in a first example of an optical inspection system in accordance with the present invention, shown in FIG. 5a. The optical inspection system 50, used for inspecting a ply of glass 51 for edge defects, includes a water-cooled red LED (light emitting diode) line light source 52, comprising a linear array of LEDs 53 having an irradiance of 500 W/m², arranged to illuminate a prism assembly 54. The prism is set up on a stand (not shown), at a distance L₁, away from an image capture device 55. A suitable image capture device 55 is a 104 k Line Scan camera, available from Basler AG, An der Strusbek 60-62, D-22926, Ahrensburg, Germany. The camera employs a CCD (charge-coupled device) sensor chip having an externally controlled timing signal, and may run in a free-run mode, outputting lines continuously. The maximum line rate is 29.2 kHz at 2048 pixels, with a 180 mm focal length through a F/3.5, f-mount macro lens. A suitable LFD line light source 52 is an LED line light available from V Cubed Limited, 1 Uplands, Marlow Bucks, SL7 3NU.

The prism assembly 54 comprises a parallelepiped glass block 56 having two triangular glass prisms 57a, 57a located on opposite sides of the block 56 at one end. The two triangular prisms 57a, 57b and the end face of the glass block 56 form a cavity in which the edge of the ply of glass 51 sits while being inspected. The triangular prisms 57a, 57b transmit light from the upper and lower surfaces of the ply of glass 51, adjacent to the edge, and the glass block 56 transmits light from the edge of the ply of glass 51 to the image capture device. Preferably, a region extending at least 10 mm from the edge of the ply of glass is inspected for both tipper and lower surfaces. The prism assembly 54, has an overall length d₁, with the length of the glass block 56 (without triangular prisms 8a, 8b) being d₂. The two triangular prisms 57a, 57b, with one end of the glass block 56, form a cavity having a length d₃. The prism assembly 54 ensures that the images of the edge and upper and lower surfaces of the ply of glass are at the same distance from the image capture device, and therefore in the same focal plane. The glass block 56 and triangular prisms 57a, 57b need not be joined together into a single optical component, but by doing so the number of adjustments needed to bring the system into focus is minimised.

When the system is in use, the ply of glass 51 is lifted from a conveyor belt and rotated by a robot arm having a vacuum sucker attachment for gripping the glass (not shown) in a horizontal plane such that each edge of the ply passes through the cavity, and is illuminated by the light source 52. The robot rotates and positions the glass linearly, keeping the edge region normal to and at a fixed distance from the camera. In this manner, the image capture device 55 can capture images of each edge of the ply of glass. Both the robot arm and image capture device 55 may be controlled by a computer (also not shown) via suitable connections. For example, the image capture device 55 may be linked to the computer via a Camera Link™ output, and interfaced using a computer/camera interface card, for example, available from National Instruments Corporation, 11500 N Mopac Expressway, Austin, Tex. 78759-3504.

For testing purposes, the following dimensions were used: L₁=200 mm, d₁=105 mm, d₂=65 mm, d₃=25 mm. The length of the side of the triangular prisms in contact with the glass block was 40 mm.

The ply of glass 51 may be viewed using either bright field (direct transmitted light) or dark field (refracted light) techniques. In general, the ground edge of the ply of glass appears bright, regardless of whether viewed in bright or dark field. The dark field image also contains information about the structure of the sample being viewed, and the contrast caused by faults such as brilliantatura is greater than when viewed in bright field. Hence dark field imaging is preferred. FIG. 5b shows the system of FIG. 5a, with reference numerals omitted for clarity, and illustrates the optical ray paths within the system when illuminated.

In order to complete the inspection of the ply of glass within a reasonable time, such that the process can be included on a production line, a maximum processing time for image capture is set at 7 seconds. This needs to include both data collection and inspection processing. In order to achieve this, it is not possible to inspect all of the images collected by eye. It is therefore preferred to use an automated system for determining the extent of any edge faults present in the ply of glass, for example, using a LabVIEW™ (available from National Instruments Corporation) image processing system. Images may be captured on a linear conveyor at speeds of up to 600 min/sec, with a spatial resolution of approximately 0.05 mm both parallel and perpendicular to the plane of the ply of glass. The image processing system is also preferably able to compensate for any vibrations of the glass during rotation by the robot.

Edge faults are detected by determining whether there are any variations in brightness in the dark field image captured, and whether there are any variations in the detected light indicating changes in the thickness of the glass ply. By setting a threshold for both brightness and thickness changes, faults may be detected to a high degree of accuracy.

Although the operation of the inspection system has been described in terms of a ply of glass inspected in a horizontal plane, the ply of glass may be inspected in an alternative plane, for example, vertically, as long as the support holding the ply during inspection is able to keep a constant distance between the edge and surfaces of the ply of glass and the cavity formed by the glass block and prisms. In order to accommodate various thicknesses of glass plies, the triangular prisms may be separate from the glass block, forming an adjustable cavity. Other suitable image capture devices or light sources may also be used. For example, the LED light source may be replaced by a fibre optic line light source which may be used in conjunction with metal halide or halogen lamps. A mirror may be used to direct all or a portion of the light from the light source towards the prism.

The key feature of the prism assembly described above is that it acts to alter the path lengths of the light received from each of the edge and adjacent surfaces by the image capture device such that the images of the edge and adjacent surfaces are focussed into the same focal plane at the image capture device. Other components which provide for a change in path length in the light received by the image capture device may be used instead.

For example, as shown in FIG. 6a, in an alternative construction, two mirrors 61a, 61b are used in place of the triangular prisms 57a, 57a to reflect light from the upper and lower surfaces of the ply of glass 51 to the image capture device 55. The parallelepiped glass block 56, placed a distance L₂ away from the image capture device 55, transmits light reflected from the edge of the ply of glass 51 to the image capture device 55, as before. L₂ is determined by the focal length of the image capture device 55. The light source 52 is positioned appropriately to achieve reflection from the edge and adjacent surfaces of the ply of glass 51. This arrangement ensures that the images of the edge and upper and lower adjacent surfaces of the glass ply 51 are the same distance from the image capture device 55, and therefore in the same focal plane. FIG. 6b shows the system of FIG. 6a, with reference numerals omitted for clarity, and illustrates the optical ray paths within the system when illuminated.

A mirror (not shown) may be used to direct all or a portion of the light from the light source 52 towards the ply of glass 51. This arrangement does not require the use of a prism arrangement, and has the advantage, as with separate prisms and block, of being able to accommodate a wide range of glass ply thicknesses, whilst ensuring that the images of the edge and upper and lower surfaces of the ply of glass are at the same distance from the image capture device.

FIG. 7 is a schematic diagram illustrating an alternative illumination system. Rather than using a single light source 52 comprising a linear array of LEDs 53, as in FIGS. 5a, 5b, 6a and 6b, four light sources 52a, 52b, 52c, 52d, each having a linear array of LEDs 53a, 53b, 53c, 53d, are placed in four different positions around the prism arrangement 54. Two light sources 52a, 52d are positioned opposite one another, each illuminating an angled surface one of the triangular prisms 57a 57b. The remaining two light sources 51b, 52c are positioned either side of the glass block 56, again illuminating the two triangular prisms 57a 57b. This illumination arrangement is used in conjunction with a slightly altered prism arrangement 54 to that shown in FIGS. 5a and 5b and camera spacing 55: L₁=252 mm, d₁=38 mm, d₂=13 mm and d₃=25 mm. By using four light sources, the increased illumination ensures that the images obtained by the linescan camber 55 are intense, clear and well defined. Although FIG. 7 illustrates the illumination arrangement in use with a prism assembly 54, it could equally well be used with the mirror arrangement shown in FIGS. 6a and 6b. In addition, other combinations or numbers of light sources could be used, dependent on ambient light conditions or other practical considerations, but at least two light sources illuminating the prism from at least two different positions are preferred.

FIG. 8 is an image of a ply of glass captured using the system shown in FIG. 5a. The edge (centre), adjacent top surface (left-hand side) and adjacent bottom surface (right-hand side) of the glass are shown. Two faults are visible on the image: a chip in the top surface of the glass (“A”, measuring approximately 3 mm×7 mm) which may also be seen on both the edge and the bottom surface, and a shiner (“B”, measuring approximately 2.2 mm×13 mm) on the edge of the glass. Both of these faults arise from edge machining. The image shows that features occurring on the edge or either surface of the glass can be imaged simultaneously, and identified easily.

Although the operation of the inspection system has been described in terms of a ply of glass inspected in a horizontal plane, the ply of glass may be inspected in an alternative plane, for example, vertically, as long as the support holding the ply during inspection is able to keep a constant distance between the edge and surfaces of the ply of glass and the mirrors and glass block of the system.

1. Glazing inspection apparatus for detecting edge faults in a ply of glass, comprising:
a light source for illuminating a ply of glass;
image capture means for capturing images of the edge and the upper and lower surfaces, adjacent the edge, of the ply of glass, and focusing means for focusing the images of the edge and the upper and lower surfaces, adjacent the edge, of the ply of glass into the same focal plane.

2. The apparatus of claim 1, wherein the focusing means comprises: a prism assembly comprising a parallelepiped glass block and two triangular glass prisms, such that the block focuses light from the edge of the ply of glass and the triangular prisms from the surfaces of the ply of glass.

3. The apparatus of claim 2, wherein the triangular prisms are located on opposite sides of the glass block at one end, and form a cavity into which the edge and upper and lower surfaces, adjacent the edge, of the ply of glass are placed.

4. The apparatus of claim 1, wherein the focusing means comprises:
a parallelepiped glass block and two mirrors, wherein the block focuses light from the edge of the ply of glass and the mirrors from the surfaces of the ply of glass.

5. The apparatus of claim 1, wherein a single image capture device is used to capture the images the edge and the upper and lower surfaces, adjacent the edge, of the ply of glass.

6. The apparatus of claim 1, wherein the image capture device is a camera.

7. The apparatus of claim 6, wherein the camera is a line scan camera.

8. The apparatus of claim 6 or, wherein the camera is a CCD (charge-coupled device) camera.

9. The apparatus of claim 1, wherein the light source is a linear array of light emitting diodes (LEDs).

10. The apparatus of claim 1, further comprising means to rotate the ply of glass such that all of the edge and the upper and lower surfaces, adjacent the edge of the ply of glass are exposed to the image capture device.

11. The apparatus of claim 1, further comprising means to detect variations in the images received by the image capture device, wherein the variations indicate the presence of edge faults.

12. The apparatus of claim 1, further comprising at least two light sources arranged to illuminate the focusing means from at least two different positions.

13. The apparatus of claim 1, further comprising four light sources, arranged to illuminate the focusing means from four different positions.

14. A method of inspecting the edge of a ply of glass for edge faults, comprising:
illuminating a ply of glass;
capturing images of the edge and the upper and lower surfaces, adjacent the edge, of the ply of glass, and
focusing the images of the edge and the upper and lower surfaces, adjacent the edge, of the ply of glass into the same focal plane using focusing means.

15. The method of claim 14, wherein the focusing means comprises: a prism assembly comprising a parallelepiped glass block and two triangular glass prisms, such that the block focuses light from the edge of the ply of glass and the triangular prisms from the surfaces of the ply of glass.

16. The method of claim 15, wherein the triangular prisms are located on opposite sides of the glass block at one end, and form a cavity into which the edge and upper and lower surfaces, adjacent the edge, of the ply of glass are placed.

17. The method of claim 14, wherein the focusing means comprises: a parallelepiped glass block and two mirrors, wherein the block focuses light from the edge of the ply of glass and the mirrors from the surfaces of the ply of glass.

18. The method of any of claim 14, wherein a single image capture device is used to capture the images the edge and the upper and lower surfaces, adjacent the edge, of the ply of glass.

19. The method of claim 14, wherein the image capture device is a camera.

20. The method of claim 19, wherein the camera is a line scan camera.

21. The method of claim 19, wherein the camera is a CCD (charge-coupled device) camera.

22. The method of claim 14, wherein the light source is a linear array of light emitting diodes (LEDs).

23. The method of claim 14, wherein at least two light sources are used to illuminate the focusing means from at least two different positions.

24. The method of claim 14, wherein at four light sources are used to illuminate the focusing means from at four different positions.

25. The method of claim 14, further comprising rotating the ply of glass such that all of the edge and the upper and lower surfaces, adjacent the edge of the ply of glass are exposed to the image capture device.

26. The method of claim 14, further comprising detecting variations in the images received by the image capture device, and using the variations to determine whether there are any edge faults present.

27. (canceled)

28. (canceled)
